(19) United States
(12) Patent Application Publication
(10) Pub. No.: US 2016/0133903 A1
(43) Pub. Date: May 12, 2016

(54) SEPARATOR FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Yeon-Joo CHOI, Yongin-si (KR); Jong-Hwan PARK, Yongin-si (KR); Jung-Hyun NAM, Yongin-si (KR); Eun-Gyeong LEE, Yongin-si (KR)

(21) Appl. No.: 14/846,312

(22) Filed: Sep. 4, 2015

(30) Foreign Application Priority Data
Nov. 7, 2014 (KR) 10-2014-0154719

(51) Int. Cl. H01M 2/16; H01M 10/052

(52) U.S. Cl. CPC H01M 2/1653; H01M 2/1686; H01M 10/052

(57) ABSTRACT

A separator for a rechargeable lithium battery and a rechargeable lithium battery including the same, the separator including a substrate; and a coating layer on at least one side of the substrate, wherein the coating layer includes a polyvinylidene fluoride-containing compound, and an acryl-containing compound represented by the following Chemical Formula 1:

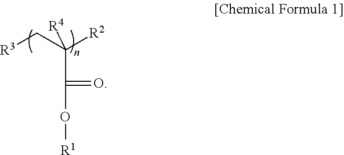

### CROSS-REFERENCE TO RELATED APPLICATION

Korean Patent Application No. 10-2014-0154719, filed on Nov. 7, 2014, in the Korean Intellectual Property Office, and entitled: “Separator for Rechargeable Lithium Battery and Rechargeable Lithium Battery Including Same,” is incorporated by reference herein in its entirety.

### BACKGROUND

1. Field

Embodiments provide a separator for a rechargeable lithium battery and a rechargeable lithium battery including the same.

2. Description of the Related Art

A rechargeable lithium battery may include a positive electrode, a negative electrode, and a separator interposed between the positive and negative electrodes.

### SUMMARY

Embodiments are directed to a separator for a rechargeable lithium battery and a rechargeable lithium battery including the same.

The embodiments may be realized by providing a separator for a rechargeable lithium battery, the separator including a substrate; and a coating layer on at least one side of the substrate, wherein the coating layer includes a polyvinylidene fluoride-containing compound, and an acryl-containing compound represented by the following Chemical Formula 1:

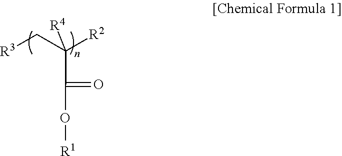

wherein, in Chemical Formula 1, each R¹ is independently hydrogen, a substituted or unsubstituted C1 to C10 alkyl group, a substituted or unsubstituted C2 to C10 alkenyl group, a substituted or unsubstituted allyl group, or a substituted or unsubstituted benzyl group, R² and R³ are each independently hydrogen, a substituted or unsubstituted C1 to C20 alkyl group, a moiety derived from acryl-based monomer, a moiety derived from an acrylonitrile-based monomer, or a moiety derived from a vinylidenefluoride-based monomer, each R⁴ is independently hydrogen or a substituted or unsubstituted C1 to C20 alkyl group, and n is an integer of about 100 to about 1,000.

The acryl-containing compound may include a copolymer of an acryl-containing monomer and an acrylonitrile-containing monomer, a copolymer of an acryl-containing monomer and a vinylidenefluoride-containing monomer, a copolymer of at least two acryl-containing monomers, or a combination thereof.

The acryl-containing compound may have a weight average molecular weight of about 100,000 g/mol to about 400,000 g/mol.

The acryl-containing compound may be included in the coating layer in an amount of about 3 parts by weight to about 20 parts by weight, based on 100 parts by weight of the polyvinylidene fluoride-containing compound.

The polyvinylidene fluoride-containing compound may include polyvinylidene fluoride (PVdF), a polyvinylidene fluoride-hexafluoropropylene (PVdF-HFP) copolymer, or a combination thereof.

The coating layer may further include a styrene-butadiene rubber, a carboxymethyl cellulose, an ethylene vinylacetate, a hydroxyethyl cellulose, a polyvinyl alcohol, a polyvinylbutyral, an ethylene-acrylic acid copolymer, an acrylonitrile, a vinyl acetate derivative, a polyethylene glycol, an acryl-containing rubber, or a combination thereof.

The embodiments may be realized by providing a rechargeable lithium battery comprising the separator according to an embodiment.

The embodiments may be realized by providing a separator for a rechargeable lithium battery, the separator including a substrate; and a coating layer on at least one side of the substrate, wherein the coating layer includes a polyvinylidene fluoride-containing compound, and an acryl-containing compound, the acryl-containing compound including a copolymer of an acryl-containing monomer and an acrylonitrile-containing monomer, a copolymer of an acryl-containing monomer and a vinylidenefluoride-containing monomer, a copolymer of at least two acryl-containing monomers, or a combination thereof.

The acryl-containing compound may have a weight average molecular weight of about 100,000 g/mol to about 400,000 g/mol.

The acryl-containing compound may be included in the coating layer in an amount of about 3 parts by weight to about 20 parts by weight, based on 100 parts by weight of the polyvinylidene fluoride-containing compound.

The polyvinylidene fluoride-containing compound may include polyvinylidene fluoride (PVdF), a polyvinylidene fluoride-hexafluoropropylene (PVdF-HFP) copolymer, or a combination thereof.

The coating layer may further include a styrene-butadiene rubber, a carboxymethyl cellulose, an ethylene vinylacetate, a hydroxyethyl cellulose, a polyvinyl alcohol, a polyvinylbutyral, an ethylene-acrylic acid copolymer, an acrylonitrile, a vinyl acetate derivative, a polyethylene glycol, an acryl-containing rubber, or a combination thereof.

### BRIEF DESCRIPTION OF THE DRAWINGS

Features will be apparent to those of skill in the art by describing in detail exemplary embodiments with reference to the attached drawings in which:

FIG. 1 illustrates a schematic view of a rechargeable lithium battery according to one embodiment.

FIG. 2 illustrates a graph showing linear sweep voltammetry (LSV) of separators for a rechargeable lithium battery according to Example 4 and Comparative Example 1.

FIG. 3 illustrates a graph showing cycle-life characteristics of rechargeable lithium battery cells according to Example 4 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

As used herein, when a definition is not otherwise provided, the term ‘substituted’ refers to one substituted with a substituent selected from a halogen atom (e.g., F, Br, Cl, I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C30 aryl group, a C7 to C30 arylalkyl group, a C1 to C20 alkoxy group, a C1 to C20 heteroalkyl group, a C3 to C20 heteroarylalkyl group, a C3 to C20 cycloalkyl group, a C3 to C20 cycloalkenyl group, a C4 to C20 cycloalkynyl group, a C2 to C20 heterocycloalkyl group, and a combination thereof, instead of hydrogen of a compound.

As used herein, when a definition is not otherwise provided, the term ‘hetero’ refers to one including 1 to 3 hetero atoms selected from N, O, S, and P.

Hereinafter, a separator for a rechargeable lithium battery according to one embodiment is described.

The separator for a rechargeable lithium battery according to one embodiment may separate negative and positive electrodes and may provide a transport passage for lithium ions. The separator may include a substrate and a coating layer on at least one side of the substrate. The coating layer may include, e.g., a polyvinylidene fluoride-based or -containing compound and an acryl-based or -containing compound.

A separator formed by coating the polyvinylidene fluoride-based compound on the substrate to form the coating layer may exhibit excellent adherence to an electrode and excellent oxidation resistance, but static electricity may be generated due to generation of a negative charge having high density on the surface of the separator. According to one embodiment, the acryl-based compound may be added to the polyvinylidene fluoride-based compound to form a coating layer on a substrate. Thus, static electricity may be not only reduced and/or prevented, but excellent adherence to an electrode substrate and oxidation resistance against the electrode plate may also be obtained. Accordingly, when the separator according to an embodiment is applied to a rechargeable lithium battery, excellent battery safety may be secured.

The polyvinylidene fluoride-based compound may include, e.g., polyvinylidene fluoride (PVdF), a polyvinylidene fluoride-hexafluoropropylene (PVdF-HFP) copolymer, or a combination thereof.

The polyvinylidene fluoride (PVdF) may have a weight average molecular weight of greater than or equal to about 1,000,000 g/mol, e.g., about 1,200,000 g/mol to about 1,500,000 g/mol. When the weight average molecular weight is within the range, adherence of the separator to an electrode, as well as adherence of a substrate to a coating layer may be improved. In addition, thermal contraction of the substrate may be suppressed, and a short circuit between positive and negative electrodes may be reduced and/or prevented.

The polyvinylidene fluoride-hexafluoropropylene (PVdF-HFP) copolymer may include, e.g., about 0.1 mol % to about 20 mol % of a repeating unit derived from hexafluoropropylene, based on a total amount or weight of the repeating unit derived from vinylidenefluoride and the repeating unit derived from hexafluoropropylene.

The polyvinylidene fluoride-hexafluoropropylene (PVdF-HFP) copolymer may have a weight average molecular weight of less than or equal to about 800,000 g/mol, e.g., about 500,000 g/mol to about 800,000 g/mol. When the weight average molecular weight is within the range, adherence of the separator to an electrode as well as adherence of a substrate to a coating layer may be improved. In addition, thermal contraction of the substrate may be suppressed, and a short circuit between positive and negative electrodes may be prevented.

The acryl-based compound may be represented by the following Chemical Formula 1.

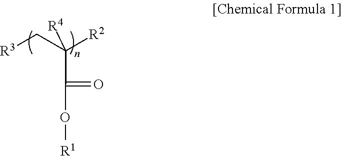

In Chemical Formula 1,

R¹ may be or may include, e.g., hydrogen, a substituted or unsubstituted C1 to C10 alkyl group, a substituted or unsubstituted C2 to C10 alkenyl group, a substituted or unsubstituted allyl group, or a substituted or unsubstituted benzyl group.

R² and R³ may each independently be or include, e.g., hydrogen, a substituted or unsubstituted C1 to C20 alkyl group, a substituent or moiety derived from acryl-based monomer, a substituent or moiety derived from an acrylonitrile-based monomer, or a substituent or moiety derived from a vinylidenefluoride-based monomer.

R⁴ may be or may include, e.g., hydrogen or a substituted or unsubstituted C1 to C20 alkyl group.

n may be an integer of, e.g., about 100 to about 1000.

In an implementation, the acryl-based compound may include, e.g., a copolymer obtained from polymerization of an acryl-based monomer and an acrylonitrile-based monomer, a copolymer obtained from polymerization of an acryl-based monomer and a vinylidenefluoride-based monomer, a copolymer obtained from polymerization of at least two acryl-based monomers, or a combination thereof. These copolymers should have excellent miscibility as they are added to the polyvinylidene fluoride-based compound as a polymer in a coating layer.

The acrylonitrile-based monomer may include, e.g., (meth)acrylonitrile or the like. The vinylidenefluoride-based monomer may include, e.g., vinylidenefluoride or the like. The acryl-based monomer may include, e.g., (meth)acrylic acid, (meth)acrylate, or the like. Examples of the (meth)acrylate may include C1 to C10 alkyl (meth)acrylate, C2 to C10 alkenyl (meth)acrylate, allyl (meth)acrylate, benzyl (meth)acrylate, and the like.

The acryl-based compound may have a weight average molecular weight of about 100,000 g/mol to about 400,000 g/mol, e.g., about 150,000 g/mol to about 350,000 g/mol. When the weight average molecular weight is within the range, excellent oxidation resistance and adherence may be secured.

The acryl-based compound may be added as an antistatic agent in the coating layer. In an implementation, the acryl-based compound may be included in the coating layer in an amount of about 3 parts by weight to about 20 parts by weight, e.g., about 5 parts by weight to about 10 parts by weight, based on 100 parts by weight of the polyvinylidene fluoride-based compound. When the acryl-based compound is included within the range, an amount of static electricity generated on the surface of the separator may be reduced.

In an implementation, the coating layer may further include, e.g., a styrene-butadiene rubber (SBR), carboxylmethyl cellulose (CMC), ethylene vinylacetate (EVA), hydroxyethyl cellulose (HEC), polyvinyl alcohol (PVA), polyvinylbutyral(PVB), an ethylene-acrylic acid copolymer, acrylonitrile, a vinyl acetate derivative, a polyethylene glycol, acryl-based or -containing rubber, or a combination thereof, in addition to the polyvinylidene fluoride-containing compound and the acryl-containing compound.

The coating layer may have a thickness of about 1 μm to about 6 μm, e.g., about 2 μm to about 4 μm. A separator including the coating layer having a thickness within the range may exhibit excellent adherence to an electrode plate and may be prevented from generating static electricity. Thus, a rechargeable lithium battery having excellent safety may be realized.

The substrate may include, e.g., a polyolefin-based resin. The polyolefin-based resin may include, e.g., a polyethylene-based resin, a polypropylene-based resin, or a combination thereof.

The substrate may include pores, through which lithium ions may move.

The substrate may have a thickness of about 1 μm to about 40 μm, e.g., about 1 μm to about 30 μm or about 1 μm to about 20 μm. When the substrate has a thickness within the range, safety of a rechargeable lithium battery may be secured due to excellent physical characteristics, while the capacity of the rechargeable lithium battery may be secured.

The coating layer may be formed by coating a coating composition (that includes the polyvinylidene fluoride-based compound, the acryl-based compound, and a solvent) on at least one side of the substrate and drying the coating composition.

The solvent may include, e.g., dimethyl acetamide, N-methyl-2-pyrrolidone, ketones such as acetone, or the like.

The coating composition may be coated using, e.g., a method of dip coating, die coating, roll coating, comma coating, or the like.

The drying may include, e.g., drying by using a warm blow, a how blow, or a low humid blow, or vacuum-drying.

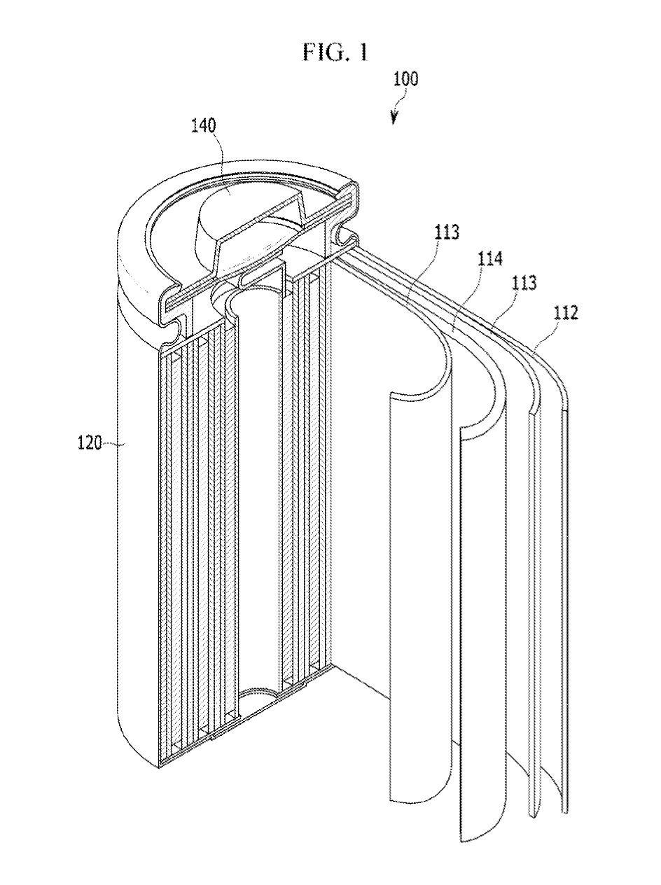

Hereinafter, a rechargeable lithium battery including the separator is described referring to FIG. 1.

FIG. 1 illustrates a schematic view showing a rechargeable lithium battery according to one embodiment.

Referring to FIG. 1, a rechargeable lithium battery 100 according to one embodiment may include an electrode assembly including a positive electrode 114, a negative electrode 112 facing the positive electrode 114, a separator 113 interposed between the negative electrode 112 and the positive electrode 114, and an electrolyte (not shown) impregnating the positive electrode 114, the negative electrode 112 and the separator 113, a battery case 120 housing the electrode assembly, and a sealing member 140 sealing the battery case 120.

The separator 113 may be the separator according to an embodiment as described above.

The positive electrode 114 may include a current collector and a positive active material layer formed on the current collector.

The current collector may include, e.g., aluminum.

The positive active material layer may include a positive active material.

The positive active material may include a compound (a lithiated intercalation compound) that is capable of intercalating and deintercallating lithium, e.g., lithium metal oxide.

The lithium metal oxide may include, e.g, an oxide including at least one metal selected from cobalt, manganese, nickel and aluminum, and lithium. For example, a compound represented by one of the following chemical formulae may be used.

LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O_{2-c}D_{c} (0.90≦a≦1.8, 0≦b≦0.5, 0≦c≦0.05); LiₐE_{2-b}X_{b}O_{4-c}D_{c} (0.90≦a≦1.8, 0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c} Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)} Fe₂(PO₄)₃ (0≦f≦2); and LiFePO₄

In the above chemical formulae, A may be selected from Ni, Co, Mn, and a combination thereof; X may be selected from Al, Ni, Co, Mn, Cr, Fe, Mg, Sr, V, a rare earth element and a combination thereof; D may be selected from O, F, S, P and a combination thereof; E may be selected from Co, Mn and a combination thereof; T may be selected from F, S, P and a combination thereof; G may be selected from Al, Cr, Mn, Fe, Mg, La, Ce, Sr, V and a combination thereof; Q may be selected from Ti, Mo, Mn and a combination thereof; Z may be selected from Cr, V, Fe, Sc, Y and a combination thereof; and J may be selected from V, Cr, Mn, Co, Ni, Cu and a combination thereof.

In an implementation, the lithium metal oxide may include, e.g., a lithium nickel cobalt manganese oxide, a lithium nickel cobalt aluminum oxide, or a combination thereof. In an implementation, the lithium metal oxide may include, e.g., a mixture of the lithium nickel cobalt manganese oxide and the lithium nickel cobalt aluminum oxide.

The positive active material layer may further include a binder and a conductive material, in addition to the positive active material.

The binder may help improve binding properties of positive active material particles with one another and with a current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may provide an electrode with conductivity. A suitable electrically conductive material that does not cause a chemical change may be used as a conductive material. Examples of the conductive material may include a carbon-based material such as natural graphite, artificial graphite, carbon black, acetylene black, ketjen black, a carbon fiber and the like; a metal-based material such as a metal powder or a metal fiber and the like of copper, nickel, aluminum, silver, and the like; a conductive polymer such as a polyphenylene derivative and the like; or a mixture thereof.

The negative electrode 112 may include a current collector and a negative active material layer on the current collector.

The current collector may include, e.g., copper.

The negative active material layer may include a negative active material and a binder. In an implementation, the negative active material may include a conductive material.

The negative active material may include a material that reversibly intercalates/deintercalates lithium ions, a lithium metal, a lithium metal alloy, a material being capable of doping and dedoping lithium, or transition metal oxide.

The material that reversibly intercalates/deintercalates lithium ions may include a carbon material, e.g., a suitable carbon-based negative active material rechargeable lithium battery. Examples thereof may include crystalline carbon, amorphous carbon, or a mixture thereof. Examples of the crystalline carbon may include graphite such as non-shaped, sheet-shape, flake, spherical shape or fiber-shaped natural graphite or artificial graphite, and examples of the amorphous carbon may include soft carbon or hard carbon, a mesophase pitch carbonized product, fired coke, and the like.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may include Si, SiOₓ (0<x<2), a Si—C composite, a Si-Q alloy (wherein, the Q is an element selected from an alkali metal, an alkaline-earth metal, Group 13 to 16 elements, a transition metal, a rare earth element, and a combination thereof, and not Si), Sn, SnO₂, a Sn—C composite, Sn—R (wherein, the R is an element selected from an alkali metal, an alkaline-earth metal, Group 13 to 16 elements, a transition metal, a rare earth element, and a combination thereof, and not Sn), and the like, and at least one of these may be mixed with SiO₂. Examples of the Q and R may be selected from, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The transition metal oxide may include vanadium oxide, lithium vanadium oxide, and the like.

The binder may help improve binding properties of negative active material particles with one another and with a current collector. Examples thereof may include polyvinyl alcohol, carboxylmethyl cellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may help improve electrical conductivity of an electrode. A suitable electrically conductive material that does not cause a chemical change may be used. Examples thereof may include a carbon-based material such as natural graphite, artificial graphite, carbon black, acetylene black, ketjen black, carbon fiber and the like; a metal-based material such as a metal powder or a metal fiber and the like of copper, nickel, aluminum, silver, and the like; a conductive polymer such as a polyphenylene derivative and the like; or a mixture thereof.

The negative electrode may be manufactured by a method including mixing the negative active material, the binder, and the conductive material in a solvent to prepare a negative active material composition, and coating the negative active material composition on a current collector. In an implementation, the solvent may include N-methylpyrrolidone or the like.

The electrolyte solution may include a non-aqueous organic solvent and a lithium salt.

The non-aqueous organic solvent may serve as a medium for transmitting ions taking part in the electrochemical reaction of a battery. The non-aqueous organic solvent may include a carbonate-based, ester-based, ether-based, ketone-based, alcohol-based, or aprotic solvent.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), or the like.

For example, when a linear carbonate compound and a cyclic carbonate compound are mixed, a solvent having a high dielectric constant and a low viscosity may be provided. In an implementation, the cyclic carbonate compound and linear carbonate compound may be mixed together in a volume ratio ranging from about 1:1 to about 1:9.

The ester-based solvent may include, e.g., methylacetate, ethylacetate, n-propylacetate, methylpropionate, ethylpropionate, γ-butyrolactone, decanolide, valerolactone, mevalonolactone, caprolactone, or the like. The ether-based solvent may include, e.g., dibutylether, tetraglyme, diglyme, dimethoxyethane, 2-methyltetrahydrofuran, tetrahydrofuran, or the like, and the ketone-based solvent may include, e.g., cyclohexanone or the like. The alcohol-based solvent may include, e.g., ethyl alcohol, isopropyl alcohol, or the like.

The non-aqueous organic solvent may be used singularly or in a mixture, and when the organic solvent is used in a mixture, the mixture ratio may be controlled in accordance with a desirable battery performance.

The non-aqueous electrolyte may further include an overcharge inhibitor additive, e.g., ethylenecarbonate, pyrocarbonate, or the like.

The lithium salt may be dissolved in an organic solvent, may supply lithium ions in a battery, may basically operate the rechargeable lithium battery, and may help improve lithium ion transportation between positive and negative electrodes therein.

Examples of the lithium salt may include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN LiN(CₓF₂ₓ₊₁SO₂)(C_{y}F_{2y+1}SO₂), wherein, x and y are natural numbers, e.g., an integer of 1 to 20, LiCl, LiI, LiB(C₂O₄)₂ (lithium bis(oxalato)borate, LiBOB), or a combination thereof.

The lithium salt may be used in a concentration ranging from about 0.1 M to about 2.0 M. When the lithium salt is included within the above concentration range, an electrolyte may have excellent performance and lithium ion mobility due to optimal electrolyte conductivity and viscosity.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

(Manufacture of Separator)

### Example 1

100 parts by weight of polyvinylidene fluoride (PVdF) having a weight average molecular weight of 1,000,000 g/mol and 3 parts by weight of a copolymer obtained by polymerizing vinylidenefluoride and acrylic acid were mixed in a dimethyl acetamide solvent to prepare a coating composition. The copolymer obtained by polymerizing vinylidenefluoride and acrylic acid had a weight average molecular weight of 200,000 g/mol.

Subsequently, the coating composition was coated on both sides of a porous substrate formed of a polyethylene to form a coating layer, manufacturing a separator. The porous substrate was 9 μm thick, and the coating layers on both sides thereof were 4 μm thick in total.

### Example 2

A separator was manufactured according to the same method as Example 1 except for using the copolymer obtained by polymerizing vinylidenefluoride and acrylic acid in an amount of 6 parts by weight, instead of 3 parts by weight.

### Example 3

A separator was manufactured according to the same method as Example 1 except for using a copolymer obtained by polymerizing acrylonitrile and hexylacrylate, instead of the copolymer obtained by polymerizing vinylidenefluoride and acrylic acid. The copolymer obtained by polymerizing acrylonitrile and hexylacrylate had a weight average molecular weight of 350,000 g/mol.

### Example 4

A separator was manufactured according to the same method as Example 3 except for using the copolymer obtained by polymerizing acrylonitrile and hexylacrylate in an amount of 6 parts by weight, instead of 3 parts by weight.

### Example 5

A separator was manufactured according to the same method as Example 1 except for using a copolymer obtained by polymerizing butylacrylate and ethylacrylate, instead of the copolymer obtained by polymerizing acrylonitrile and hexylacrylate. The copolymer obtained by polymerizing butylacrylate and ethylacrylate had a weight average molecular weight of 200,000 g/mol.

### Example 6

A separator was manufactured according to the same method as Example 5 except for using the copolymer obtained by polymerizing butylacrylate and ethylacrylate in an amount of 6 parts by weight, instead of 3 parts by weight.

### Comparative Example 1

A separator was manufactured according to the same method as Example 1, except for omitting the copolymer obtained by polymerizing vinylidenefluoride and acrylic acid. The coating layer had a cross-section thickness of 3.6 μm.

(Manufacture of Rechargeable Lithium Battery Cell)

LiCoO₂, polyvinylidene fluoride, and carbon black in a weight ratio of 97:1.5:1.5 were added to an N-methylpyrrolidone (NMP) solvent, preparing slurry. The slurry was coated on an aluminum (Al) thin film and then dried and compressed, manufacturing a positive electrode.

Then, graphite, a styrene-butadiene rubber, and carboxymethyl cellulose in a weight ratio 98:1:1 were added to a water solvent, preparing slurry. The slurry was coated on a copper foil and then dried and compressed, manufacturing a negative electrode.

An electrolyte solution was prepared by mixing ethylene carbonate (EC), ethylmethyl carbonate (EMC), and diethyl carbonate (DEC) in a volume ratio of 3:5:2 and adding LiPF₆ to the mixed solvent to prepare a 1 M solution.

The positive and negative electrodes and the electrolyte solution were used respectively along with the separators according to Examples 1 to 6 and Comparative Example 1, manufacturing each rechargeable lithium battery cell.

Evaluation 1: Ventilation Degree of Separator

The ventilation degree of each separator according to Examples 1 to 6 and

Comparative Example 1 was measured in the following method, and the results are provided in the following Table 1.

The separator was cut into a size of 6 cm×6 cm, and its ventilation degree was measured by using a gurley densometer. The ventilation degree was measured by injecting 100 cc of air with a predetermined pressure into the separator and measuring how long it took for the air to completely pass pores of the separator.

Evaluation 2: Static Electricity Amount of Separator

Static electricity amount of each separator according to Examples 1 to 6 and

Comparative Example 1 was measured in the following method, and the results are provided in the following Table 1.

The 6 cm×6 cm separator was electrified to generate static electricity, and its charge amount was measured by an electrostatic charge amount-measuring instrument.

Evaluation 3: Adherence of separator to Electrode Plate

Adherence of each separator according to Examples 1 to 6 and Comparative Example 1 to the positive and negative electrodes was evaluated in the following method, and the results are provided in the following Table 1.

The positive electrode/separator/negative electrode/separator/positive electrode in an order were stacked in an aluminum pouch, 0.3 g of the electrolyte solution was injected into the pouch, and the pouch was sealed. The electrolyte solution was prepared by mixing ethylene carbonate (EC), ethylmethyl carbonate (EMC), and diethyl carbonate (DEC) in a volume ratio of 3:5:2 and adding LiPF₆ to the mixed solvent to prepare a 1 M solution. The sealed pouch was compressed with a roller applying a predetermined force and heat-pressed at 90° C. for 120 seconds with 200 kgf. The pouch was cooled down and then, opened, and interface adherence of the separator with the positive electrode and interface adherence of the separator to the negative electrode were measured by using UTM.

TABLE 1

| | | | Adherence | | | |
|---|---|---|---|---|---|---|
| | | | Negative | | Positive | |
| | | | electrode | | electrode | |
| | | Static | Max- | | Max- | |
| | Ven- | elec- | imum | Average | imum | Average |
| | tilation | tricity | peel | peel | peel | peel |
| | degree | amount | strength | strength | strength | strength |
| | (s/100 cc) | (Kv) | (N) | (N) | (N) | (N) |
| Example 1 | 167 | 1.90 | 0.218 | 0.175 | 0.455 | 0.342 |
| Example 2 | 170 | 1.33 | 0.225 | 0.176 | 0.500 | 0.379 |
| Example 3 | 169 | 1.96 | 0.220 | 0.177 | 0.567 | 0.498 |
| Example 4 | 170 | 1.10 | 0.233 | 0.177 | 0.683 | 0.552 |
| Example 5 | 165 | 1.92 | 0.217 | 0.176 | 0.492 | 0.420 |
| Example 6 | 170 | 1.40 | 0.230 | 0.177 | 0.513 | 0.471 |
| Comparative | 154 | 3.50 | 0.217 | 0.174 | 0.424 | 0.301 |
| Example 1 | | | | | | |

Referring to Table 1, the separator including a coating layer formed by using a polyvinylidene fluoride-based compound and an acryl-based compound (according to Examples 1 to 6) exhibited an excellent ventilation degree and a much reduced static electricity amount, compared with the separator including a coating layer formed of only the polyvinylidene fluoride-based compound according to Comparative Example 1 and also, showed excellent adherence to an electrode. Accordingly, the separators of Examples 1 to 6 exhibited minimal generation of static electricity, and may secure a rechargeable lithium battery cell having excellent safety.

Evaluation 4: Oxidation Resistance of Separator

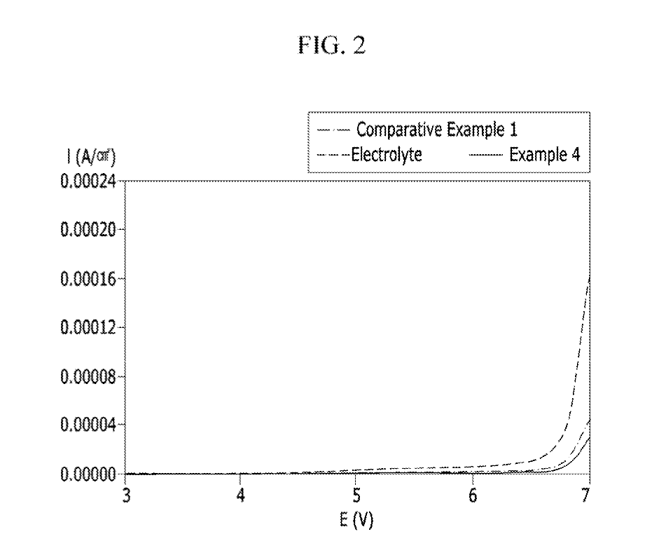

The oxidation electrode decomposition of the electrolyte solution about the separators according to Example 4 and Comparative Example 1 was evaluated by measuring anodic polarization with linear sweep voltammetry (LSV), and the results are provided in FIG. 2. As the electrolyte solution, the electrolyte solution prepared by mixing ethylene carbonate (EC), ethylmethyl carbonate (EMC), and diethyl carbonate (DEC) in a volume ratio of 3:5:2 and adding LiPF₆ to the mixed solvent was used. Furthermore, for reference, the oxidation electrode decomposition of the electrolyte solution, itself, prepared by mixing ethylene carbonate (EC), ethylmethyl carbonate (EMC), and diethyl carbonate (DEC) in a volume ratio of 3:5:2 and adding LiPF₆ to the mixed solvent, was measured by measuring anodic polarization with linear sweep voltammetry (LSV), and the results are provided as an indication of the electrolyte solution in FIG. 2.

The measurement was performed by using a three-electrode electrochemical cell using a working electrode and a Li metal as a reference electrode and a counter electrode. For the working electrode, for Example 4, Pt coated with polyvinylidene fluoride and the copolymer obtained by polymerizing acrylonitrile and hexylacrylate, was used, for Comparative Example 1, Pt coated with polyvinylidene fluoride, was used, for the reference, for the reference, i.e., the electrolyte solution, a Pt electrode was used. Herein, an electrolyte solution had the same composition as the electrolyte solution used to manufacture of the rechargeable lithium battery cells according to Example 4 and Comparative Example 1.

FIG. 2 illustrates a graph showing linear sweep voltammetry (LSV) of the separators for a rechargeable lithium battery cells according to Example 4 and Comparative Example 1.

Referring to FIG. 2, Example 4 (in which both the polyvinylidene fluoride-based compound and the acryl-based compound were included in the coating layer of the separator) showed oxidation decomposition at a higher voltage, compared with Comparative Example 1 (in which acryl-based compound was omitted from the coating layer of the separator). Accordingly, the separator according to an embodiment may exhibit excellent oxidation resistance.

Evaluation 5: Cycle-life Characteristics of Rechargeable Lithium Battery Cell

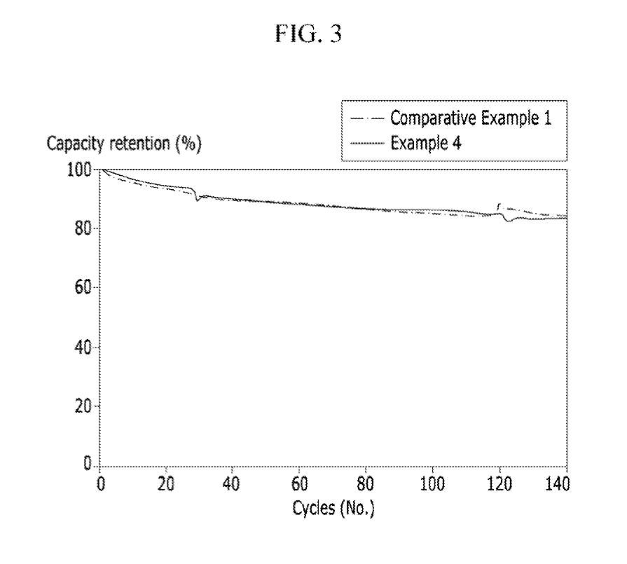

The rechargeable lithium battery cells according to Example 4 and Comparative Example 1 were charged and discharged at 45° C. under a 1 C/1 C charge and discharge condition, their cycle-life characteristics were evaluated, and the results are provided in FIG. 3.

FIG. 3 illustrates a graph showing cycle-life characteristics of the rechargeable lithium battery cells according to Example 4 and Comparative Example 1.

Referring to FIG. 3, excellent high temperature cycle-life characteristics were maintained even though an acryl-based compound was added to a coating layer formed of a polyvinylidene fluoride-based compound.

By way of summation and review, a separator may include micropores, and the micropores may play a role of electrically insulating the positive and negative electrodes as well as providing a passage for movement of lithium ions. In addition, the separator may shut down the battery when the battery temperature goes over a predetermined temperature and thus, may play a role of helping to prevent the battery from being overheated.

This separator may be formed by coating a polymer on a substrate to help improve adherence to an electrode. However, the winding process for preparing the battery using the separator may cause drawbacks such as a bad position into which a negative electrode is inserted, a bad position of a negative electrode tab, or the like.

The embodiments may provide a separator for a rechargeable lithium battery having improved safety by preventing generation of static electricity.

For example, the separator may realize a rechargeable lithium battery having improved safety by preventing static electricity.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator for a rechargeable lithium battery, the separator comprising:
a substrate; and
a coating layer on at least one side of the substrate,
wherein the coating layer includes:
a polyvinylidene fluoride-containing compound, and
an acryl-containing compound represented by the following Chemical Formula 1: 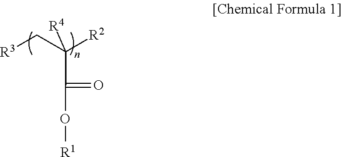
wherein, in Chemical Formula 1,
each R¹ is independently hydrogen, a substituted or unsubstituted C1 to C10 alkyl group, a substituted or unsubstituted C2 to C10 alkenyl group, a substituted or unsubstituted allyl group, or a substituted or unsubstituted benzyl group,
R² and R³ are each independently hydrogen, a substituted or unsubstituted C1 to C20 alkyl group, a moiety derived from acryl-based monomer, a moiety derived from an acrylonitrile-based monomer, or a moiety derived from a vinylidenefluoride-based monomer,
each R⁴ is independently hydrogen or a substituted or unsubstituted C1 to C20 alkyl group, and
n is an integer of about 100 to about 1,000.

2. The separator for a rechargeable lithium battery as claimed in claim 1, wherein the acryl-containing compound includes a copolymer of an acryl-containing monomer and an acrylonitrile-containing monomer, a copolymer of an acryl-containing monomer and a vinylidenefluoride-containing monomer, a copolymer of at least two acryl-containing monomers, or a combination thereof.

3. The separator for a rechargeable lithium battery as claimed in claim 1, wherein the acryl-containing compound has a weight average molecular weight of about 100,000 g/mol to about 400,000 g/mol.

4. The separator for a rechargeable lithium battery as claimed in claim 1, wherein the acryl-containing compound is included in the coating layer in an amount of about 3 parts by weight to about 20 parts by weight, based on 100 parts by weight of the polyvinylidene fluoride-containing compound.

5. The separator for a rechargeable lithium battery as claimed in claim 1, wherein the polyvinylidene fluoride-containing compound includes polyvinylidene fluoride (PVdF), a polyvinylidene fluoride-hexafluoropropylene (PVdF-HFP) copolymer, or a combination thereof.

6. A rechargeable lithium battery comprising the separator as claimed in claim 1.

7. A separator for a rechargeable lithium battery, the separator comprising:
a substrate; and
a coating layer on at least one side of the substrate,
wherein the coating layer includes:
a polyvinylidene fluoride-containing compound, and
an acryl-containing compound, the acryl-containing compound including a copolymer of an acryl-containing monomer and an acrylonitrile-containing monomer, a copolymer of an acryl-containing monomer and a vinylidenefluoride-containing monomer, a copolymer of at least two acryl-containing monomers, or a combination thereof.

8. The separator for a rechargeable lithium battery as claimed in claim 7, wherein the acryl-containing compound has a weight average molecular weight of about 100,000 g/mol to about 400,000 g/mol.

9. The separator for a rechargeable lithium battery as claimed in claim 7, wherein the acryl-containing compound is included in the coating layer in an amount of about 3 parts by weight to about 20 parts by weight, based on 100 parts by weight of the polyvinylidene fluoride-containing compound.

10. The separator for a rechargeable lithium battery as claimed in claim 7, wherein the polyvinylidene fluoride-containing compound includes polyvinylidene fluoride (PVdF), a polyvinylidene fluoride-hexafluoropropylene (PVdF-HFP) copolymer, or a combination thereof.

11. The separator for a rechargeable lithium battery as claimed in claim 7, wherein the coating layer further includes a styrene-butadiene rubber, a carboxymethyl cellulose, an ethylene vinylacetate, a hydroxyethyl cellulose, a polyvinyl alcohol, a polyvinylbutyral, an ethylene-acrylic acid copolymer, an acrylonitrile, a vinyl acetate derivative, a polyethylene glycol, an acryl-containing rubber, or a combination thereof.
